(19) United States
(12) Patent Application Publication
(10) Pub. No.: US 2011/0101267 A1
(43) Pub. Date: May 5, 2011

(54) ACID TREATMENT UNDER LOW TEMPERATURE AND PRESSURE OF WASTE CONTAINING ASBESTOS

(75) Inventors: Joelle Carpena, Jouques (FR); Jean-Louis Lacout, Toulouse (FR)

(73) Assignees: INSTITUT NATIONAL POLYTECHNIQUE DE TOULOUSE, Toulouse (FR); UNIVERSITE PAUL CEZANNE-AIX MARSEILLE III, AIX EN PROVENCE (FR); CENTRE NATIONAL DE LA RECHERCHE SCIENTIFIQUE (C.N., Paris (FR)

(21) Appl. No.: 12/990,465

(22) PCT Filed: Apr. 30, 2009
(86) PCT No.: PCT/FR2009/050804

§ 371 Date: Jan. 18, 2011

(30) Foreign Application Priority Data
Apr. 30, 2008 (FR) 0852923

(51) Int. Cl. C09K 3/00

(52) U.S. Cl. 252/182.33

(57) ABSTRACT

The present invention relates to a process for treating a waste containing asbestos, comprising a step (E) in which the asbestos contained in said waste is dissolved by reacting this waste with an acid other than hydrofluoric acid, preferably with hydrochloric acid, at a temperature of at least 125° C. and at a pressure greater than 0.2 M Pa (2 bar), and in which: the asbestos included in the treated waste is an asbestos of amphibole type; and/or the solution obtained at the end of the acid dissolution of the asbestos is reused, for example for the synthesis of apatites.

The present invention relates to the field of asbestos removal, and more specifically to that of the treatment of waste containing asbestos. More specifically, the invention relates to a novel method allowing conversion of inhalable acicular asbestos fibers into a non-inhalable form.

The term of “asbestos”, in the sense in which it is used, in the sense of the present description, is understood in its widest meaning, and is thus directed to silicate hydrates naturally formed during metamorphism of certain rocks and for which an adequate mechanical treatment reveals acicular mineral fibers. For more details on this subject, reference may notably be made to Deer M. A., Howie R. A. and Zusman J., Rock Forming Minerals, Vol. 2, Ed. Longman (1971).

The term of “asbestos” in the sense of the present description notably includes:
asbestos minerals of the serpentine type, which generally appear as fibers with a length of less than or equal to 40 mm and a diameter of the order of 0.02 microns, among which mention may be made of chrysotile of formula Mg₃Si₂O₅(OH)₄ (CAS number: 12007-29-5);
   and
asbestos minerals of the amphibole type, which are silicates generally appearing as fibers with a length of less than or equal to 70 mm and a diameter of the order of 0.08 to 0.1 microns, and which notably include:
   asbestos of the cummingtonite type, which fit the general formula (Fe,Mg)₇Si₈O₂₂(OH)₂ (CAS number: 12172-73-5), such as for example grunerites, also designated by the term of “amosite” which is at the origin of a trade name given to these asbestos by the AMOS company (Asbestos Mines of South Africa); and
   asbestos minerals of the crocidolite type which fit the general formula Na₂(Fe,Mg)₃Al₂Si₈O₂₂(OH)₂ (CAS number: 12001-28-4).

The risks of severe repercussion on health and on the environment in applying asbestos, in particular of the amphibole type, are today known. Because of this recognized dangerousness of asbestos, legal requirements concerning the handling of this material have become increasingly strict, and this most particularly when dealing with asbestos in the flocked state, i.e. in the form of acicular fibers only pressed together and letting through air. In fact, when asbestos removal techniques are applied, the asbestos removal area is generally secured by applying powerful vacuum cleaners aiming at avoiding that fibers may be conveyed by air and the operators are generally further protected by protective suits.

Work carried out on asbestos has shown that risks related to the use of this material exist especially when asbestos appears as inhalable particles, notably as free acicular fibers, the inhalation of particles of this type being capable of inducing fibrous or cancerous formations notably in the human body, which may be expressed by the outbreak of diseases of the lung cancer or asbestosis type. Pathologies of this type have been ascribed to the acicular form of the asbestos fibers but also to an effect of the ions released after partial dissolution of asbestos at living tissues.

Considering these risks, waste containing asbestos is considered as dangerous industrial waste, and during these recent years, development of techniques have been sought, with which it may be confined or efficiently removed. It should be noted concerning this that there exist many waste materials of this type, which are essentially flocked asbestos products for heat insulation or asbestos cements which were currently used, notably in France, for example in the field of the building industry and public civil engineering, until the 1997 ban on the manufacturing and utilization of products containing asbestos fibers.

A first solution which was proposed for managing waste containing asbestos is the one consisting of storing the waste based on asbestos in centers for storing dangerous waste. This confinement is a not very satisfactory solution, notably insofar that it does not involve any treatment capable of making the waste harmless and that it consequently leads to accumulation of dangerous waste on a sensitive site. In addition the storage capacities in storage centers are not unlimited and they further have a non-negligible cost.

Another solution applied today consists of achieving vitrification of the asbestos-based waste by bringing this waste to a high temperature (of the order of 10,000° C.) typically by using a plasma torch. Such a vitrification of asbestos proves to be an efficient technique for treating asbestos, since it leads to a conversion of any type of asbestos into a vitrified material unable to release inhalable fibers of acicular asbestos. Nevertheless, a major drawback of this vitrification method is its very high cost, due to very significant energy consumption related to the use of a plasma torch as well as to cost of setting up and of maintaining high technology devices which it involves. Further, the asbestos vitrication technique has a relatively reduced treatment capacity (22 tons a day for the only installation of this type existing in Europe, i.e. 8,000 tons a year), which is very little as compared with the very large amounts of asbestos-based waste which has to be treated today (as an indication, in France, the yearly amount of waste containing asbestos is of the order of 200,000 tons of flocked asbestos and 20 million tons of asbestos-cement. Moreover 3,000 types of asbestos-containing products have been inventoried (2005-2006 French Senate Information Report of G. Dériot and J. P. Godefroy) and, today, about 100 million square meters of French buildings are still with asbestos).

Solutions other than vitrification have been contemplated in order to treat asbestos-based waste, which however have proved to be inapplicable in practice, or less efficient than vitrification.

Thus, it has for example been suggested to destroy the acicular structure of the asbestos fibers by submitting these fibers to intensive milling with the aim of inducing amorphization of asbestos.

On the other hand, it has been suggested to carry out acid etching of the asbestos with the purpose of solubilizing its acicular fibers.

Within this scope, a radical method consists in acid etching of asbestos by concentrated hydrofluoric acid. This etching proves to be very efficient, but it can only be contemplated at a laboratory scale. Indeed, the toxicity and the risks related with the use of hydrofluoric acid prevent its industrial application.

The use of acids other than the aforementioned hydrofluoric acid has been suggested, but etching by these other acids proves to be generally inefficient for treating most asbestos. Thus, for example, a treatment for dissolving asbestos with hydrofluoric acid added with potassium ions and possibly other acids, at temperatures of the order to 30 to 95° C. is for example described in WO 97/27902. The process described in this document may of course prove to be efficient with certain types of asbestos, notably asbestos of the chrysotile type, but it most often proves to be unsuitable for treating asbestos of the amphibole type (notably cummingtonites (specially amosites) and crocidolites), and this most particularly when dealing with flocked asbestos. Many publications in fact establish that acid etching of asbestos as a rule remains very limited to the surface of the acicular fibers of the asbestos, in particular when dealing with asbestos of the amphibole type, which seems to be explained by the formation of a surface gel which would prevent etching of the core of the asbestos fibers. For more details concerning this, reference may notably be made to “Dissolution of fibrous silicates in acid and buffered salt solutions”, Allen M. P. and Smith R. W., Minerals Engineering, Vol. 7, 1527-1537 (1994).

Thus, as a result, there is today a need for an efficient and inexpensive method allowing efficient conversion of inhalable acicular asbestos fibers into a non-inhalable form, and this for all the types of asbestos, and notably for asbestos of the amphibole type such as cummingtonite or crocidolite.

An object of the present invention is to provide such a process.

For this purpose, the object of the present invention is a process for treating waste containing asbestos, comprising a step (E) wherein the asbestos contained in said waste is dissolved by having this waste react with an acid other than hydrofluoric acid at a temperature of at least 125° C. and at a pressure above 0.2 MPa (i.e. at a pressure of at least 2 bars) and wherein:
the asbestos comprised in the treated waste is an asbestos of the amphibole type;

and/or
the solution obtained at the end of the acid dissolution of asbestos is recovered for use.

According to an advantageous embodiment, step (E) of the process of the invention is conducted by placing a mixture containing the waste to be treated and an aqueous solution of the acid other than hydrofluoric acid within an autoclave enclosure, and by bringing this autoclave to a temperature above 125° C. Under these conditions, the pressure within the autoclave enclosure attains at least the steam pressure at the relevant temperature, and therefore de facto a value of at least 0.2 MPa: indeed, by operating in this way, a pressure of 0.24 MPa is reached when the temperature is 125° C. and the pressure increases with the temperature (as an indication, the pressure is 1.55 MPa (i.e. 15.5 bars) for a temperature of 200° C., and of 4 MPa (i.e. 40 bars for a temperature of 250° C.).

Preferentially, in step (E) of the process of the invention, the reaction temperature of the waste and of the acid is greater than or equal to 150° C., and more preferentially still greater than or equal to 170° C.

Moreover, it is most often advantageous if the pressure at which the reaction of the waste and of the acid is conducted in step (E), is greater than or equal to 0.5

MPa (i.e. greater than or equal to 5 bars) and more preferentially still greater than or equal to 0.8 MPa (i.e. greater than or equal to 8 bars).

Within the scope of the work which has led to the present invention, the inventors have now discovered quite unexpectedly that when asbestos is treated with an acid under the aforementioned specific temperature and pressure conditions, substantial dissolution of the asbestos is obtained with the acid, which allows, while using a sufficient amount of acid, dissolution of the totality of the asbestos present in an asbestos-containing waste, and ever if the asbestos used is of the serpentine or amphibole type. Further, the dissolution proves to be efficient both with waste containing flocked asbestos and with waste containing asbestos cement. In all the cases, the dissolution further proves to occur with sufficiently high kinetics, compatible with an industrial application of the method.

These results prove to be most particularly surprising considering the studies conducted up to now on the dissolution of asbestos in an acid medium, which rather suggested that acid etching of asbestos with an acid other than hydrofluoric acid is a naturally incomplete reaction, notably when asbestos is of the amphibole type.

On the contrary, the inventors have now demonstrated that it is possible to carry out dissolution of the totality of the asbestos contained in waste with an acid other than hydrofluoric acid, including when this asbestos is of the amphibole type, and this simply by conducting the reaction of the acid with the asbestos at sufficient temperature and pressure.

Within this scope, still more surprisingly, it is found that the temperatures and pressure adapted to total acid dissolution of asbestos do not need to be very high, which is notably expressed by a relatively reduced process cost and therefore facilitates a large scale application of the method.

Thus, in the most general case, the reaction of the waste with acid in step (E) may advantageously be conducted at a temperature of less than or equal to 300° C., for example between 180° C. and 250° C. and notably between 200 and 220° C. (higher temperatures are of course not excluded within the scope of the invention, but they are by no means imposed for reaching the sought result).

Also, the reaction of the waste with the acid in step (E) may be conducted at a pressure which generally does not have to exceed 5 MPa (50 bars), this pressure being advantageously comprised between 1 and 4 MPa (i.e. between 10 and 40 bars).

The inventors further demonstrated that the dissolution of asbestos may be attained very easily under the conditions of the invention without necessarily having to apply concentrated acid to accomplish this.

Thus, the application of the process of the invention allows extremely simple, rapid and efficient conversion of asbestos fibers, initially capable of being inhaled, into a transformed compound different from the initial asbestos and no longer containing any inhalable particles, and this with an extremely reduced energy cost. The method of the invention therefore is a very advantageous alternative to the vitrification method presently recommended for treating asbestos.

Further, unlike the vitrification method applied today for treating asbestos, which leads to vitrified asbestos which is a not very interesting and low value material (the main application (or even unique application) of vitrified asbestos is its use as a road surfacing sublayer), the process of the present invention itself leads to a solution (S) stemming from the asbestos, which may be recovered for use, as such. Advantageously, in the process of the invention, this solution (S) is recovered for use as such.

More specifically, the inventors have indeed demonstrated now that the solution (S) from the dissolution of asbestos as obtained at the end of the step (E) of the process of the invention may notably be used for recovering one or several of the elements contained in this solution (Mg, Al and/or Fe, in particular), notably as:
salts of the acid used for carrying out the acid etching of step (E) (for example in the form of chlorides directly obtained in the solution (S) when hydrochloric acid is used in step (E); or
as hydroxides for example obtained by adding a strong base of the soda or potash type into the solution (S); or
as iron minerals.

In particular, it is possible to recover from the solution (S), magnesium salts or hydroxides, this recovery of magnesium proving to be most particularly advantageous, considering the increasing price of magnesium in strong demand in particular in the metallurgical industry.

More specifically, the inventors have moreover demonstrated that the solution (S) from the dissolution of asbestos during step (E) may, according to an advantageous embodiment, be used for synthesizing an apatite from the asbestos initially contained in the waste. For this purpose, the process of the invention then comprises advantageously the following steps (E1) and (E2) at the end of step (E):

(E1) phosphate PO₄³⁻ ions and Ca²⁺ calcium ions are introduced into the asbestos solution (S) obtained at the end of step (E), which may be achieved very simply, i.e.:
either by adding into the solution (S) after step (E):
   a mixture of a compound containing phosphate ions and of a compound containing calcium ions; or
   a calcium phosphate (for example tricalcium phosphate TCP),
or, more preferentially, by initially introducing into the reaction medium, before applying step (E):
   a mixture of a compound containing phosphate ions and of a compound containing calcium ions; or
   a calcium phosphate (like tricalcium phosphate),

the thereby introduced phosphate ions and the calcium ions then being retained during step (E) and being found again in fine in the solution (S).

(It should be noted concerning this that it is technically more interesting to add phosphate and calcium Ca²⁺ ions before applying step (E) than adding them later on notably because this suppresses an addition and mixing step. Further, the phosphate may be dissolved during a single reaction in step (E). Further, and surprisingly, it was observed more fundamentally by the inventors that the addition of phosphate and calcium Ca²⁺ ions before applying step (E) rather than afterwards, leads to an increase in the kinetics of the dissolution reaction of asbestos in step (E));

and then

(E2) the solution (S) with phosphate and calcium additives from step (E1) is basified, whereby precipitation of an apatite is obtained.

Within this scope, the invention thus provides a novel method for preparing a silicate apatite which, according to a particular aspect, is another specific and particularly interesting aspect of the present invention.

The process for preparing silicate apatite of the invention comprising the aforementioned steps (E1) and (E2) proves to be most particularly interesting when the waste treated in step (E) comprises asbestos of the amphibole type. Indeed, in this case, the method leads to silicate apatite containing iron cations, of the type of the one described for example in the international applications WO 95/02886 or WO 00/15546, which proves to be useful notably as an agent for scavenging arsenic or heavy metals such as Pb, Cd, U, Pu, Th or Cr, such a silicate apatite containing iron may for example be used for decontaminating soils or waste water contaminated by heavy ions, or for scavenging heavy metals, notably uranium or plutonium, notably when these are apatites of the type of those described in WO 00/15546.

According to an interesting embodiment, when the method of the invention includes the steps (E1) and (E2) for recovering for use the solution (S) from step (E), the phosphate ions and the calcium Ca²⁺ ions may advantageously be introduced in the step (E1) as a product from the calcination of animal meal. In this case, the method of the invention proves to be most particularly interesting from the point of view of treating waste: indeed it allows joint treatment of two dangerous wastes (i.e. waste comprising asbestos on the one hand and animal meal on the other hand) in order to convert them into a material of interest, i.e. an apatite, which itself proves to be capable of decontaminating soils or polluted waters or of confining other harmful or dangerous wastes, and this most particularly when asbestos contained in the initial waste is asbestos of the amphibole type.

The method of the invention preferably has one or several of the following preferential characteristics.

In step (E), the applied acid preferably comprises sulfuric or hydrochloric acid. More preferentially, this acid is hydrochloric acid, sulfuric acid or a mixture of these acids. In a more advantageous way, it more often proves to be preferable to use hydrochloric acid, in particular when steps (E1) and (E2) are applied. The invention is however not limited to applying these particular acids and the acid dissolution of step (E) may lead to applying other acids, preferably strong acids other than hydrofluoric acid. In step (E), most often, the reaction medium does not contain any hydrofluoric acid. Applying hydrofluoric acid jointly with the acid of step (E) is however not excluded, although this is not generally desirable. Moreover, the acid used in step (E) is preferentially applied as an aqueous solution. More generally, it is moreover most often desirable that the reaction medium of step (E) contains water.

On the other hand, in step (E), the molar acid/ asbestos ratio is preferably greater than 1:1, and more preferentially between 1.2:1 and 1.8:1. The duration of step (E) should notably be adapted according to this ratio and to the exact nature of the treated asbestos. In the most general case, total dissolution of the asbestos initially contained in the waste does not require any reaction exceeding 100 h and is most often obtained in less than 50 h. Advantageously, this duration is at least 1 h, preferably at least 2 h and is typically of the order of 5 to 50 h.

Different aspects and advantages of the invention will become still further apparent upon considering the illustrative examples discussed hereafter.

### EXAMPLE 1

### Dissolution of Asbestos of the Amosite Type With Hydrochloric Acid

In an autoclave enclosure, 2,500 mL of an aqueous solution of 1N hydrochloric acid are introduced, where 2 g of flocked asbestos of the amosite type of formula Fe_{5,66}Mg_{1,47}Si₈O₂₂(OH)₂ were then placed.

The autoclave enclosure was closed and then placed in an oven, the temperature of which was programmed as follows:
a rise in temperature from room temperature (25° C.) to 200° C. in 60 minutes;
maintaining the temperature at 200° C. for 48 hours (at this temperature, the pressure within the autoclave enclosure is brought to 15.5 bars (1.55 MPa)

After 48 hours of treatment at 200° C., the autoclave enclosure is removed from the oven and is left to cool to room temperature (25° C.) for a duration of about one hour (the pressure inside the autoclave declining because of atmospheric pressure (1 bar)).

Total dissolution of the asbestos is thereby obtained: at the end of the treatment, an aqueous solution (S1) free of any solid phase is actually obtained in the autoclave enclosure. The obtained solution appears to be perfectly limpid when simply observed visually. Observation with a binocular microscope at a magnification of x 500 confirms that there no longer is any solid phase and in particular no residual fiber.

Thus, in the obtained solution (S1), asbestos no longer exists in its initial mineral form: it has been totally dissolved and is found in a totally dissociated ionic form. Therefore, in particular, there is no longer any presence of the fibrous structure responsible for the effects of the initial flocked asbestos on human health and on the environment.

### EXAMPLE 2

### Conversion of Asbestos of the Amosite Type into an Iron Apatite (Acid Dissolution of the Asbestos and then Recovery and Exploitation of the Obtained Solution)

The acid dissolution of Example 1 was reproduced, except that 20 g of calcium phosphate (tricalcium phosphate TCP as a powder) was added into the autoclave in addition to the 2,500 mL of hydrochloric acid solution and to the 2 g of amosite before applying the heat treatment.

After a heat treatment at 200° C. similar to the one of Example 1 followed by free cooling down to room temperature (and return of the pressure to 1 bar) for about 1 hour, a solution (S2) free of any solid phase was obtained by acid dissolution of the asbestos. There again, the thereby obtained solution appeared to be perfectly limpide when observed visually, and observation with a binocular microscope at a magnification of ×500 confirms that there no longer is any solid phase and in particular no residual fiber.

The thereby obtained solution (S2) was introduced dropwise in 5,000 mL of an aqueous 1N soda solution, whereby very fast precipitation of a reddish powder consisting of apatite associated with iron oxides and hydroxides (this apatite is notably useful as a scavenging agent for arsenic or heavy metals such as Pb, Cd, U, Pu, Th or Cr) was obtained.

Similar results are obtained applying calcium phosphates other than the TCP applied in the present example (notably with hydroxyapatite, fluoroapatite or carbonate-apatite or further still with incineration residues of animal meals).

1. A process for treating waste containing asbestos, comprising a step (E), which comprises reacting the waste in a reaction medium comprising an acid other than hydrofluoric acid at a temperature of at least 125° C. and at a pressure above 0.2 MPa, thereby dissolving the asbestos contained in said waste in said reaction medium, and wherein
the asbestos comprised in the treated waste is asbestos of the amphibole type;
and/or
a solution (S) obtained after acid dissolution of the asbestos is recovered for use.

2. The process according to claim 1, wherein step (E) comprises placing a mixture containing the waste to be treated and the reaction medium within an autoclave enclosure, and bringing the autoclave to the temperature above 125° C.

3. The process according to claim 1, wherein, in step (E), the reaction temperature of the waste with the acid is greater than or equal to 150° C.

4. The process according to claim 1, wherein, in step (E), the reaction temperature of the waste with the acid is between 180° C. and 250° C.

5. The process according to any of claim 1, wherein, in step (E), the pressure at which the reaction of the waste and of the acid is conducted is greater than or equal to 0.5 MPa.

6. The process according to claim 1, wherein, in step (E), the pressure at which the reaction of the waste and of the acid is conducted, is between 1 and 4 MPa.

7. (canceled)

8. The process according to claim 1, wherein the acid used in step (E) comprises hydrochloric acid or sulfuric acid.

9. The process according to claim 1, wherein the acid used in step (E) is hydrochloric acid.

10. The process according to claim 1, wherein, in step (E), the acid/ asbestos molar ratio is between 1.2:1 and 1.8:1.

11. The process according to claim 1, wherein, following step (E), one or more elements selected from the group consisting of Mg, Al and Fe contained in the solution (S) are recovered from the dissolution of asbestos.

12. The process according to claim 1, comprising the following steps after step (E):
(E1) introducing_phosphate PO₄³⁻ ions and calcium Ca²⁺ ions into the solution (S) obtained at the end of step (E); and then
(E2) adjusting the pH of the solution (S) with phosphate and calcium additives from step (E1) to be basic, whereby precipitation of an apatite is obtained,
whereby silicate apatite is synthesized from the asbestos initially contained in the waste.

13. The process according to claim 1, wherein, prior to step (E), phosphate ions and calcium ions are introduced into the reaction medium, wherein the phosphate ions and calcium ions are provided by:
a mixture of a compound containing phosphate ions and of a compound containing calcium ions; or
a calcium phosphate,
whereby the introduced phosphate ions and calcium ions are retained during step (E) and remain in the solution (S) at the end of step (E).

14. The process according to claim 12, wherein the asbestos initially contained in the waste treated in step (E) is an asbestos of the amphibole type, and wherein, at the end of step (E2), a silicate apatite containing iron is obtained.

15. The process according to claims 12 or 13, wherein the phosphate ions and the calcium ions are introduced as a product from the calcination of animal meal.

16. The process of claim 13, wherein said calcium phosphate is tricalcium phosphate.
